(19) United States
(12) Patent Application Publication
(10) Pub. No.: US 2011/0289544 A1
(43) Pub. Date: Nov. 24, 2011

(54) VIDEO STREAMING SYSTEM INCLUDING A FAST CHANNEL CHANGE MECHANISM

(76) Inventors: Hendrik A. Goosen, Mountain View, CA (US); Edward J. Rak, Los Altos, CA (US)

(21) Appl. No.: 12/782,909

(22) Filed: May 19, 2010

(51) Int. Cl. H04N 7/173

(52) U.S. Cl. 725/116; 725/118

(57) ABSTRACT

A video stream server transmits a multicast stream for a number of digital television channels, and a digital television receiver receives the multicast stream. The video stream server may transmit to the television receiver a unique unicast stream for the selected channel at a rate that is faster than a multicast stream live stream rate in response to a channel change request for a selected channel. The video stream server may further transmit as a first packet of the unicast stream, a random access point (RAP) that occurred prior to a current packet of video content of a multicast stream. The digital television receiver may send the RAP for decoding and display upon receipt, and store to the memory unit a number of successive packets corresponding to the multicast stream for the selected channel subsequent to receiving and storing the successive packets corresponding to the unicast stream.

### BACKGROUND

1. Technical Field

This disclosure relates to video streaming systems such as digital television systems including a fast channel change mechanism.

2. Description of the Related Art

Many digital television broadcasting systems such as traditional cable television (CATV) and Internet protocol television (IPTV), for example, and other streaming video systems use compression to reduce the amount of data that is needed to represent a video for storage and transmission. There are several different compression schemes in common use, and all of them make a distinction between intraframe compression (i.e., one that uses only the data contained in one picture frame) and interframe compression (i.e., one that uses data from multiple picture frames). One such compression technique that is used extensively in the broadcast industry is a version of the motion picture expert group (MPEG) compression known as MPEG-2, although other emerging compression techniques such as MPEG-4 are also being used.

In an MPEG-2 video stream, there are typically three picture types: Intraframe (I) pictures, Predictive (P) pictures, and Bi-directional (B) pictures. The pictures may also be referred to as frames. The I-frames are generally encoded without reference to any other frame and allow for random access. The P-frames are encoded using motion compensated prediction based on the previous frame and include reference to the previous frame, and may also be used in subsequent predictions. The B-frames are encoded using motion compensated prediction based on the previous and next B and P frames. Thus the I-frames may contain all of the information necessary to decode and display an image, whereas the P and B frames may only contain difference information. Accordingly, an I-frame may also be referred to as a random access point (RAP). A group of pictures can be formed using a specified sequence of the I, P, and B frames. Generally, the group must start with a RAP and have some number of following P and possibly B frames Likewise, most video compression schemes in common use support the notion of a RAP.

Generally speaking, streams that are sent to a number of receivers are referred to as broadcast or multicast streams depending the type of system, while streams delivered to a specific receiver are typically called unicast streams. For example, in an IPTV system, when a number of users receiving live TV all select channel 5 on their digital television receivers, each television receiver may issue a multicast “join” request to access the IP multicast stream corresponding to channel 5. This multicast stream can be delivered from a streaming video server or from another device, for example an encoder. This is in contrast to a unicast video stream that is sent from the server to a single receiver such as may be used in video on demand.

In conventional streaming video systems such as those used in digital television broadcasting, the channel change lag time can be significant. At least a portion of this lag is caused by a receiver such as a set to box (STB), for example, synchronizing the broadcast or multicast stream before it can begin decoding and displaying content. The synchronizing of the broadcast or multicast stream requires waiting for a RAP, which as described above, only occurs periodically in the stream. This delay can be as long as a few seconds in some systems and may be unacceptable to many viewers.

### SUMMARY

Various embodiments of a video streaming system including a fast channel change mechanism are disclosed. In one embodiment, the system includes a digital video stream server that may generate and transmit a multicast video stream for a number of digital television channels. The system may also include a digital television receiver that may receive the multicast video stream and may transmit a channel change request to the digital television stream server for a selected channel. The digital video stream server may also generate and transmit to the digital television receiver a unique unicast video stream for the selected channel at a rate that is faster than a rate that corresponds to a multicast video stream live stream rate in response to receiving the channel change request for the selected channel. Each video stream may include one or more successive packets of video content. The digital video stream server may further select and transmit as a first packet of the unicast video stream, a reference packet such as a RAP, for example, that occurred prior to a current packet of video content of a multicast video stream for the selected channel. The digital television receiver may also receive the reference packet followed by the successive packets corresponding to the unicast video stream for the selected channel. The digital television receiver may send the reference packet for decoding and display upon receipt. In addition the digital television receiver may receive and store to the memory unit a number of successive packets corresponding to the multicast video stream for the selected channel subsequent to receiving and storing the successive packets corresponding to the unicast video stream. Further, the digital television receiver may retrieve from the memory unit and send for decode and display the successive packets of video content corresponding to the unicast video stream and the multicast video stream in the order received.

In one particular implementation, the digital television receiver may also receive the successive packets corresponding to the unicast video stream for the selected channel at a rate that is faster than a rate that corresponds to a multicast video stream live stream rate.

In another particular implementation, the digital television receiver may request the unicast stream be discontinued in response to detecting that the successive packets corresponding to the unicast video stream for the selected channel are received at a rate that corresponds to the multicast stream live stream rate.

### BRIEF DESCRIPTION OF THE DRAWINGS

FIG. 1 is a block diagram of one embodiment of a digital video streaming system.

FIG. 2 is a block diagram of an embodiment of a digital television receiver of FIG. 1.

FIG. 3 is a diagram depicting one embodiment of the timing of transmitted multicast and unicast video streams.

FIG. 4 is a conceptual diagram depicting an embodiment of stream splicing via the multicast buffer of the receiver of FIG. 2.

FIG. 5 is an operational flow diagram describing the operation of the embodiments of FIG. 1 through FIG. 4.

FIG. 6 is a diagram depicting another embodiment of the timing of transmitted multicast and unicast video streams.

FIG. 7 is a conceptual diagram depicting another embodiment of stream splicing via the multicast buffer of the receiver of FIG. 2.

FIG. 8 is an operational flow diagram describing the operation of the embodiments of FIG. 1 and FIG. 2, and FIG. 6 and FIG. 7.

Specific embodiments are shown by way of example in the drawings and will herein be described in detail. It should be understood, however, that the drawings and detailed description are not intended to limit the claims to the particular embodiments disclosed, even where only a single embodiment is described with respect to a particular feature. On the contrary, the intention is to cover all modifications, equivalents and alternatives that would be apparent to a person skilled in the art having the benefit of this disclosure. Examples of features provided in the disclosure are intended to be illustrative rather than restrictive unless stated otherwise.

As used throughout this application, the word “may” is used in a permissive sense (i.e., meaning having the potential to), rather than the mandatory sense (i.e., meaning must). Similarly, the words “include,” “including,” and “includes” mean including, but not limited to.

Various units, circuits, or other components may be described as “configured to” perform a task or tasks. In such contexts, “configured to” is a broad recitation of structure generally meaning “having circuitry that” performs the task or tasks during operation. As such, the unit/circuit/component can be configured to perform the task even when the unit/circuit/component is not currently on. In general, the circuitry that forms the structure corresponding to “configured to” may include hardware circuits. Similarly, various units/circuits/components may be described as performing a task or tasks, for convenience in the description. Such descriptions should be interpreted as including the phrase “configured to.” Reciting a unit/circuit/component that is configured to perform one or more tasks is expressly intended not to invoke 35 U.S.C. §112, paragraph six, interpretation for that unit/circuit/component.

### DETAILED DESCRIPTION

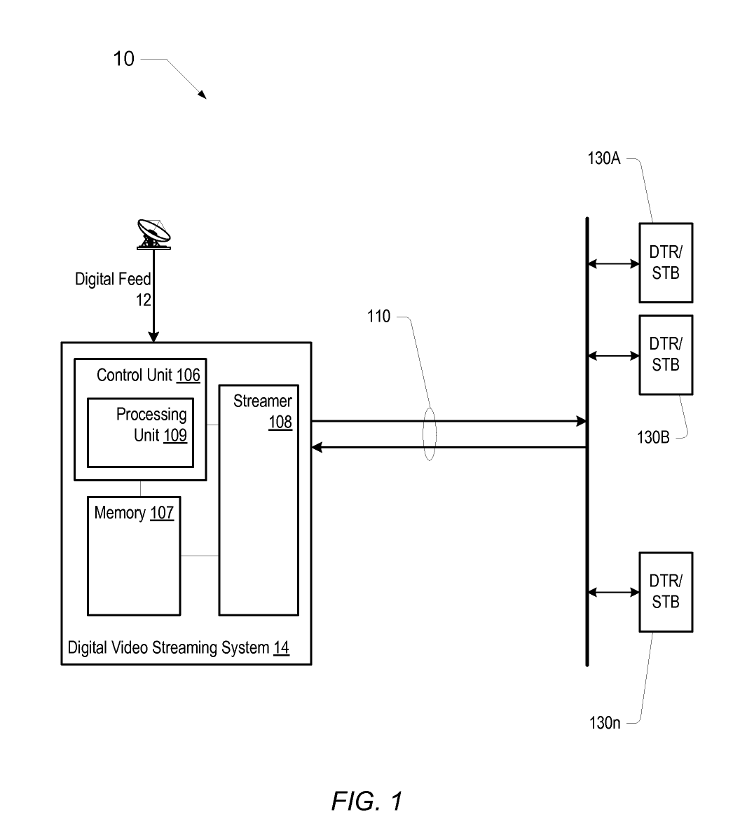

Turning now to FIG. 1, a block diagram of one embodiment of a digital streaming video system is shown. The digital streaming video system 10 includes a digital video streaming server (DVSS) 14 that is coupled to a number of DTR/STB units, designated 130A-130n, where n may be any whole number constrained only by the specific system implementation. As shown, the DVSS 14 may be configured to receive digital broadcast programs via digital feed 12 (e.g., via satellite, landline, etc.) and convert them for delivery to the DTR/STB units 130A-130n via link 110. It is noted that components that include a number and a letter may be referred to by the number only where appropriate such as, for example, DTR/STB 130 may be used when referring generally to any DTR/STB. It is further noted that in some embodiments, there may be additional components that are not shown for simplicity.

In various embodiments, digital streaming video system 10 may be implemented in a variety of video broadcasting systems. More particularly, as mentioned above, digital streaming video system 10 may be used in a CATV system that uses a canonical cable HFC architecture such as the SCTE DVS 073, for example, and in an IPTV system.

In a CATV embodiment, the DVSS 14 may be part of a centralized head end (not shown) that feeds content to one or more distribution hubs and distribution nodes (both not shown) using fiber optic cable. At a distribution node the optical signals are converted to electrical signals and distributed over coaxial cable to the DTR/STB units 130 in a given location. Accordingly, link 110 in FIG. 1 may be representative of a variety of signal types and including the video stream, forward and reverse data channels, etc. and may therefore include distribution hubs and nodes along with the appropriate interfaces.

In an IPTV embodiment, the DVSS 14 may be part either a centralized or a distributed architecture. In either architecture the DVSS 14 may convert live TV feeds into multicast or unicast video streams. In addition, DVSS 14 may store video content for use in video on demand (VOD) unicast streams. In the IPTV embodiment, link 110 may be any of a variety of distribution mechanisms including wireless and satellite links, wireline links such as twisted pair, coax, and fiber optic links, and the like.

As mentioned above, in CATV systems, the video content streams delivered to multiple users are typically referred to as broadcast streams. However, in IPTV systems, a video content stream delivered to multiple users is referred to as an IP multicast stream.

In both systems, video content streams delivered to a specific receiver are typically referred to as unicast streams. Accordingly, when referring generally to video streams delivered from DVSS 14 to multiple users, either of the terms multicast or broadcast may be used interchangeably.

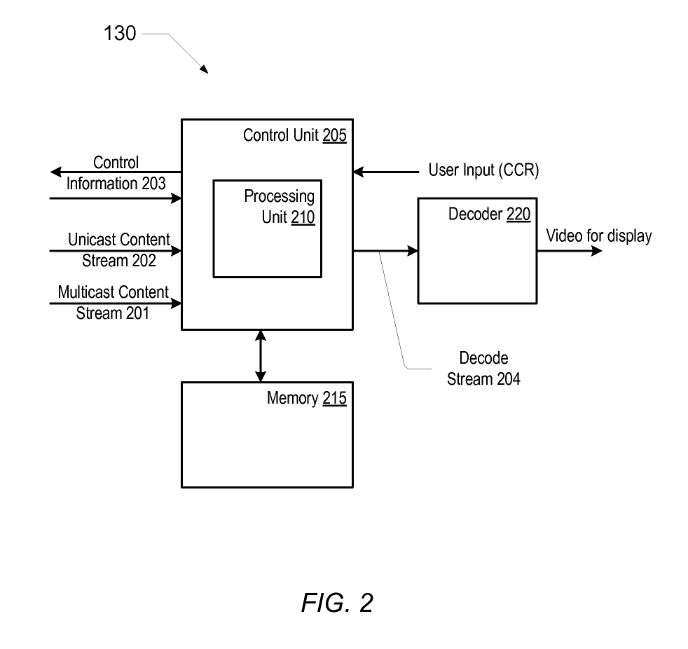

In one embodiment, DTR/STB 130 is a special-purpose graphics and communications computer that may be located at a subscriber's home or office, for example. The DTR/STB 130 may include one or more processors (shown in FIG. 2) that may execute application software. A receiver such as DTR/STB 130 typically exhibits a number of characteristics such as at least one tuner that can receive an ATSC or DVB digital TV channel. The digital TV channel can contain a MPEG-2 transport stream (TS) (that can itself contain several separate video and audio streams). In addition, the DTR/STB 130 may include a video display system that can perform various graphics processing functions, a remote control device that enables a user to interact with the graphical user interface presented by a DTR/STB application. The DTR/STB 130 may also provide an out-of-band bidirectional communications system that can exchange IP packets with application servers in the cable head end over the forward and reverse data channels. Furthermore, the DTR/STB 130 may provide a conditional access system (not shown) that may include a secure element for descrambling the input channel. It is noted that in one embodiment, the DTR/STB 130 may be a stand alone set top box while in other embodiments the functionality associated with the DTR/STB 130 may be any video display device, for example, part of a programmable receiver section of a digital television, or embedded within a computer or mobile device such as a mobile phone.

In one embodiment, the DTR/STB 130 may communicate over the out-of-band signal channels using commands that are compliant with a real time streaming protocol (RTSP), which corresponds to IETF Request for Comments (RFC) 2326. The RTSP defines an extensible framework to enable controlled, on-demand delivery of real-time data, such as audio and video. It is noted that the commands may be compliant with all of the protocol defined in the RFC 2326 or a portion (e.g., Section 10). For example, future versions of the RTSP may be backward compatible with all or part of RFC 2326. More particularly, commands such as setup, play, pause, record, teardown, and so on, may be communicated using RTSP.

The above functionality may allow a subscriber to view live and recorded content, as well as VOD content. In addition, while viewing digital television a subscriber may request a channel change using for example, setup and play commands. As will be described in greater detail below, the DVSS 14 may be configured to provide the content for the newly selected channel at a reduced latency when compared to conventional systems that were mentioned above.

In the illustrated embodiment, the DVSS 14 includes a control unit 106, a memory 107, and a streamer 108. The DVSS 14 may be configured to receive and format media content such as video, for example, for subsequent live and on-demand viewing. As will be described further below, in one embodiment the DVSS 14 may provide digital video content to multiple DTR/STB 130 units using multicast video streams that may originate at one or more broadcast networks and be received on the digital feed 12. In one embodiment, in response to a request for a channel change from a particular DTR/STB 130, the DVSS 14 may initiate and send a unique unicast video stream for the newly selected channel to the particular requesting DTR/STB 130. The DVSS 14 may further discontinue the unicast stream in response to a request from the particular DTR/STB 130.

In one embodiment, the control unit 106 includes a processing unit 109. The processing unit may include any number of CPUs and in some embodiments, processing unit 109 may be implemented as a blade server and include a number of CPU blades. As such, the processing unit 109 may be configured through software to implement any of a variety of functions including control functionality for communicating with the streamer 108, memory 107, and also to communicate with the various DTR/STBs 130 via the out of band communication links and to receive requests such as channel change requests, for example. The control functionality may also interface to the rest of the head-end infrastructure such as a subscriber database, billing, and asset management.

In addition, in one embodiment processing unit 109 may also implement video preprocessing of the incoming video streams from the digital feed 12. More particularly, the preprocessing functionality may receive incoming MPEG-2 content streams, both prerecorded and live, and process the streams into a form suitable for storage and transmission including trick play features and optimized Random Access Point structures. Streams may be preprocessed incrementally for real-time operation, or batched for more efficient operation. In one embodiment, the input MPEG-2 content stream may be received in a constant bit rate (CBR) format. The processing unit 109 may be configured to extract information such as timing and frame information, for example, from the input CBR stream. In addition, the processing unit 109 may encapsulate IP packets into MPEG-2 TS, for example. Video content transmitted through the DVSS 14 may be divided into offline content, which may be acquired, processed, and stored ahead of time, and live content, which may be acquired, processed, and transmitted on the fly. Most live content may be stored, but some live content may be transmitted to the rest of the system without requiring storage (for example, the stream system operator may not have legal rights to store a particular piece of content). Accordingly, the processing unit 109 may further instruct the memory 107 to either store the content or to simply bypass or stream it by streamer 108

In one embodiment, to facilitate fast channel changes the DVSS 14 may maintain RAP indices that correspond to the optimal transition points in the content that is sent to subscribers and viewers via multicast video streams. Accordingly, as the video content streams are created by the processing unit 109, indices that include the location of the RAPs of the various multicast segments may be maintained. This information may then be used by processing unit 109 when a channel change request is received and a unicast video stream is created for the requested channel.

In the illustrated embodiment, the memory unit 107 includes at least one storage array (not shown). The memory unit 107 may provide non-transient non-volatile content storage for the DVSS 14. In one implementation the memory unit 107 may comprise a high-density disk array that is scalable in units of tens of Terabytes, for example, to provide very large content libraries without requiring content replication. In addition, the memory unit 107 may be implemented as a high-performance redundant array of inexpensive disks (RAID) network disk storage system in which a storage controller may be configured to provide RAID controller functionality. It is noted that in alternative embodiments, the memory unit 107 may be implemented using other types of non-volatile storage media including flash memory, RAM disk, or optical media such as R/W CD-ROM or DVD, for example, among others.

In one embodiment, the streaming unit 108 may be configured to function as a centralized head end unit that combines the function of video content streaming, memory-based content caching, and network connectivity.

As described above, the DVSS 14 may also be configured to deliver a combination of multicast and unicast streams as necessary in response to user requests. For example, a user may be viewing a particular digital channel, for example, that is being delivered using multicast streams. However, if the user requests a trick play, or a different channel, the DVSS 14 may switch to a unicast arrangement for that user. In one implementation, the control unit 106 in conjunction with the streaming unit 108 may be configured to create the unicast stream on the fly for that user. This capability may allow the streaming unit 108 to reduce the bandwidth requirements for content going to multiple subscribers while providing for unique targeted content to a subscriber when necessary.

Turning to FIG. 2, a block diagram of one embodiment of a digital television receiver such as the DTR/STB 130 of FIG. 1 is shown. The DTR/STB 130 of FIG. 2 includes a control unit 205 that is coupled to a memory 215, and to a decoder 220. The DTR/STB 130 is coupled to send and receive control information 203 such as out of band signaling, for example to/from DVSS 14. In addition, control unit 205 is coupled to receive unicast content 202 and multicast content 201 from the DVSS 14. Further the DTR/STB 130 is coupled to receive user input (e.g., channel change requests) from any input device such as a remote control device via wireless link or from a keypad on the enclosure (not shown).

The decoder 220 may be configured to create a decoded content stream (e.g., decode stream 204) from an encoded video content stream and to reconstruct images and video for display. For example, the decode process may be thought of conceptually as the inverse of the encoding process. More particularly, using MPEG-2 as an illustrative example, the decode content stream 204 includes a series of groups of I, P, and B frames or packetized versions of those frames as described above. Accordingly, the decoder 220 starts the decoding process for each group by decoding a RAP (I-frame in the case of the MPEG-2 example here) followed by a particular sequence of P and B packets in each group to form the video images.

The memory 215 may be representative of any type of memory. In one embodiment, memory 215 may be implemented using any of the devices in the dynamic random access (DRAM) family of memory devices. Alternatively, memory 215 may include any of the devices in the non-volatile memory family such as a hard disk drive, or storage media including flash memory, RAM disk, or optical media such as R/W CD-ROM or DVD, for example, among others. The memory 215 may be used to store program code executed by processing unit 210. Memory 215 may also be used to as a buffer to store incoming video content stream packets.

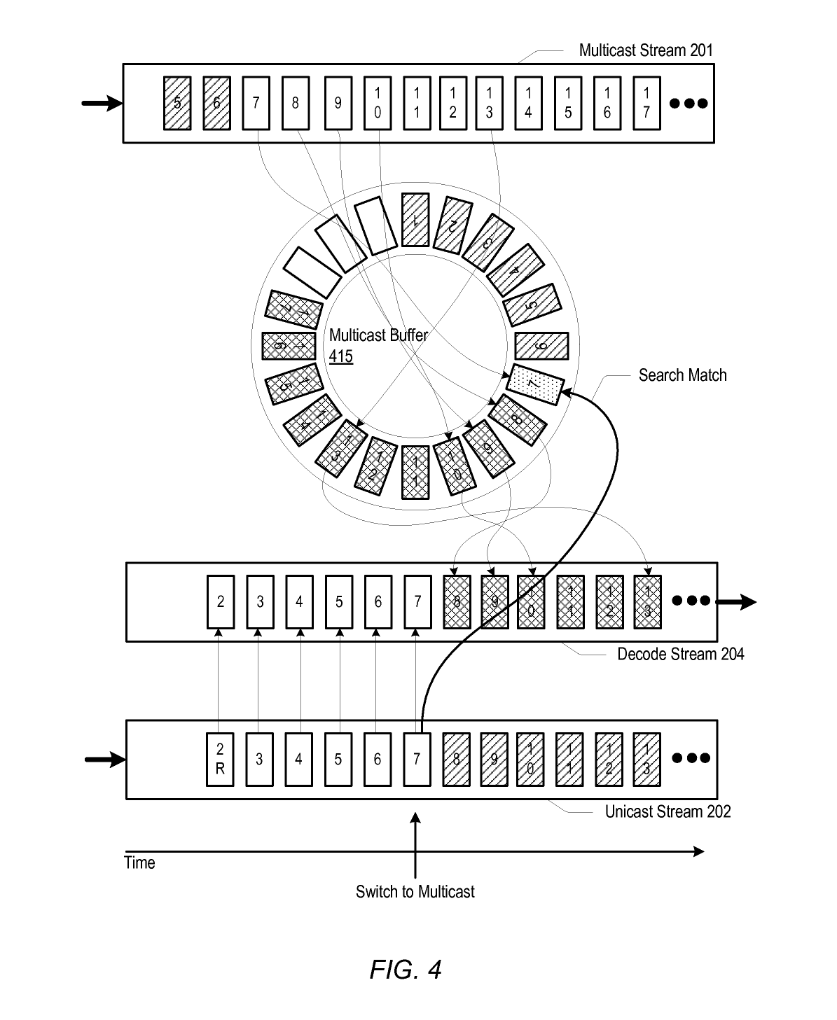

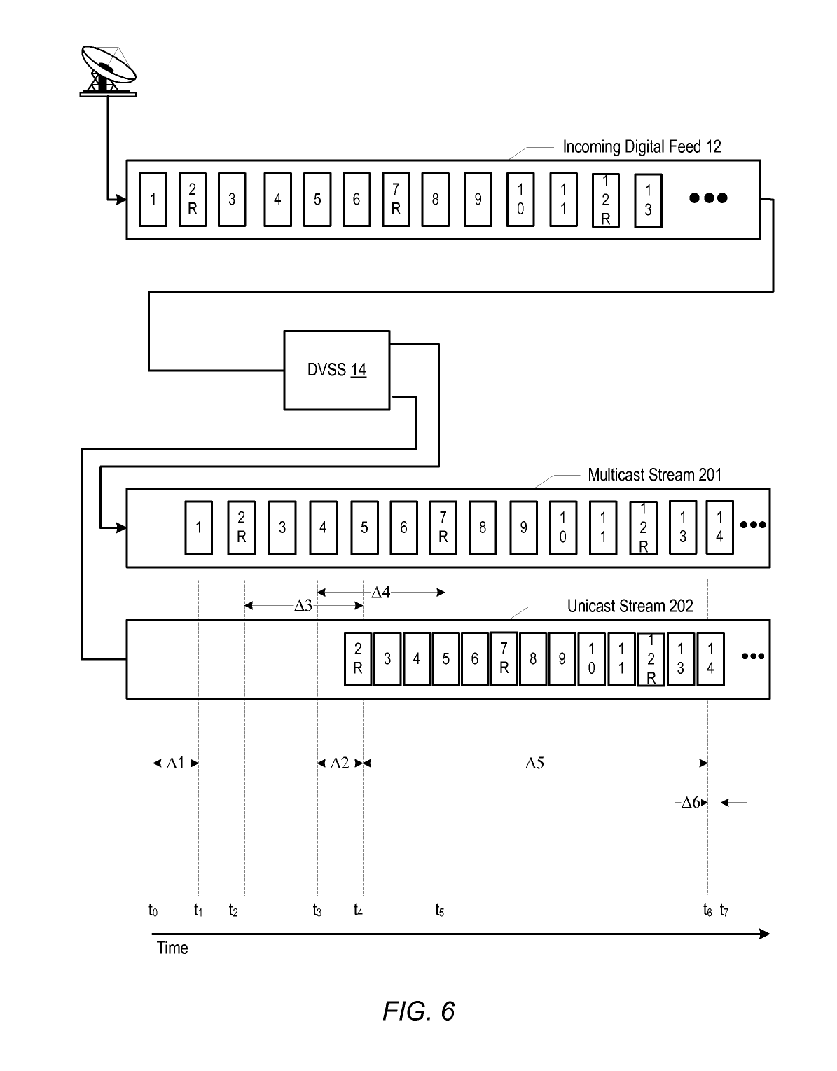

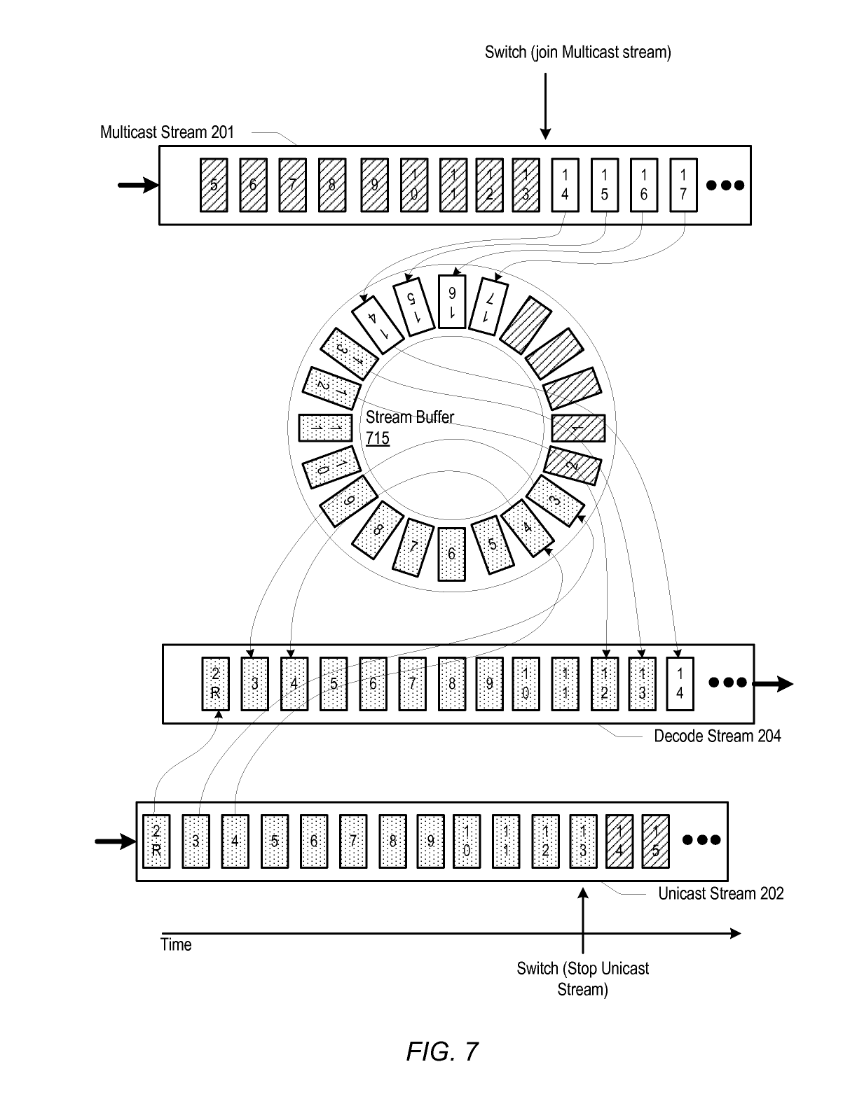

In one embodiment, in response to receiving a channel change request from the remote input device or from a channel selection button on the enclosure of the DTR/STB 130 itself, processing unit 210 may allocate blocks of memory 215 to be used as a circular buffer (shown in FIG. 4) to store multicast video stream packets. In addition, the processing unit 210 may also control the timing of the storage and retrieval of the multicast stream as well as the splicing of the unicast stream with the multicast stream to create the decode stream 204 for the decoder 220. However, as described further below in conjunction with the description of FIG. 6-FIG. 8, in an alternative embodiment, the processing unit 210 may allocate blocks of memory 215 to be used as a circular buffer (shown in FIG. 7) to store both multicast and unicast video stream packets.

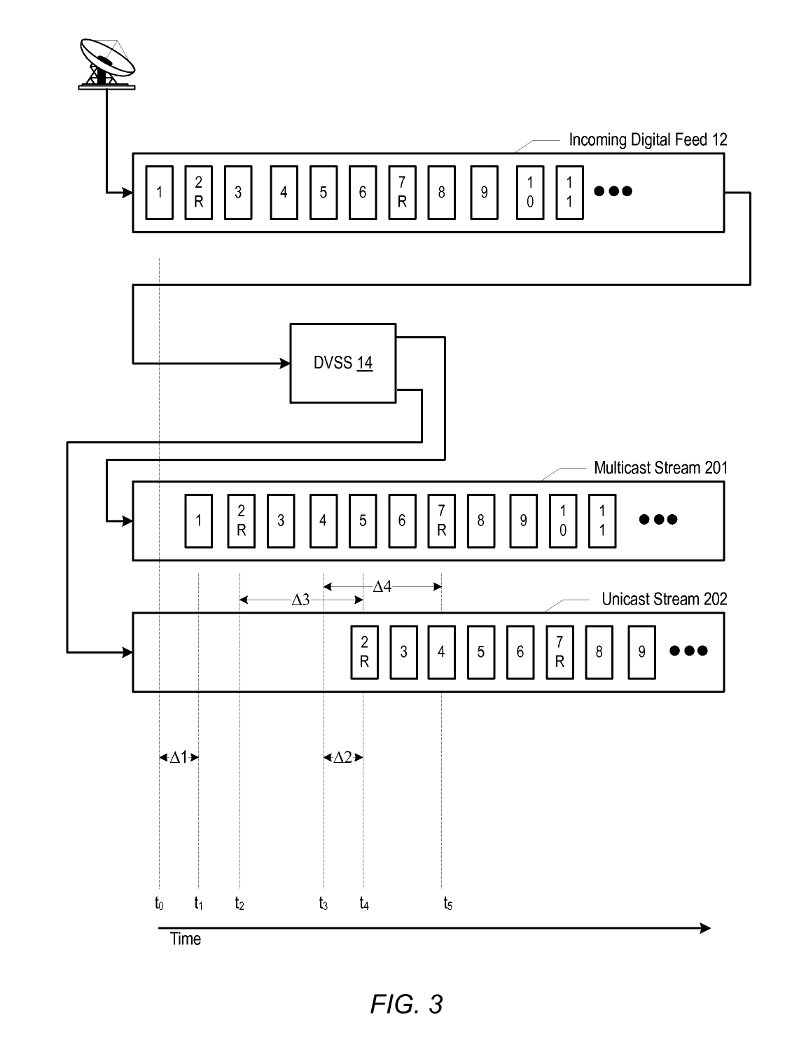

Referring to FIG. 3, a diagram depicting one embodiment of the timing of transmitted multicast and unicast video streams is shown. In the illustration, an incoming digital feed 12 is received by a DVSS 14, which creates and transmits both a multicast stream 201 and an associated unicast stream 202. There is a timeline drawn on the bottom in which time proceeds from left to right.

In the illustrated embodiment, each of the streams (e.g., 12, 201, 202) includes a number of packets of video content. In particular, each stream includes two packets containing RAPs designated by the ‘R’. It is noted that the RAP frames/packets may also be referred to as reference frames/packets.

As shown there are delays associated with the generation and transmission of the multicast stream 201. More particularly, at time t0 packet 1 of the incoming digital feed 12 is received by the DVSS 14. At time t1, packet 1 is transmitted by the DVSS 14. The delay between t0 and t1 is denoted as Δ1 and is the processing and delivery time used by the DVSS 14. At time t3, a channel change request is received by the DVSS 14. The DVSS 14 begins sending the unicast stream beginning with packet 2 (i.e., a packet containing a RAP), and at time t4, the DTR begins decoding from the RAP in packet 2 of the IP unicast stream. The channel change lag time from the time the user initiates a channel change request to the time the content is decoded in the unicast stream 202 is denoted as Δ2. It is noted that the unicast stream 202 is behind (i.e., delayed in reference to) the multicast stream 201 in time. More particularly, packet 2 of the associated multicast stream 201 has already been sent. The delay or skew between the multicast stream 201 and the unicast stream 202 is denoted as Δ3 and represents the amount of time the multicast stream 201 may be buffered. The DVSS 14 also starts sending the multicast stream 201, and at time t4 the DTR begins buffering the multicast stream 201 beginning with packet 5. In this exemplary diagram, packet 5 is the first identical packet received on both the multicast and unicast streams. Thus, when packet 5 of the unicast stream 202 is received by the DTR, the DTR will no longer decode the unicast stream 202, and will begin retrieving and decoding the multicast stream 201. The channel change lag time from the time the user initiates a channel change request to the time the content is decoded in the multicast stream for a conventional system is denoted as Δ4, since the conventional system would have to wait for the RAP in packet 7 of the multicast stream 201 to begin decoding the stream productively. The reduction in channel change lag of the illustrated embodiment corresponds to the difference between Δ4 and Δ2.

Turning to FIG. 4, a conceptual diagram depicting an embodiment of stream splicing via the multicast buffer of the receiver of FIG. 2. As described above, in response to a channel change request, the DVSS 14 starts the multicast stream 201, which may typically already be in-progress, and the unicast stream 202. As the DTR 130 receives the unicast stream packets (e.g., packets 2-7), they are passed through to form the decode stream 204 to be decoded and displayed. However, the packets in the multicast stream 201 are buffered within multicast buffer 415. More particularly, the control unit 205 of FIG. 2, may begin storing the multicast stream 201 packets into a multicast buffer 415 data structure such as a circular buffer structure within memory 215 until the control unit 215 finds a matching packet in the incoming unicast stream 202.

In one embodiment, as each unicast stream packet is received, it is compared with a target packet within the buffered multicast packets. In one implementation, the first complete packet of the multicast stream 201 may be used as the target packet. In the illustrated embodiment of FIG. 4, the exemplary target packet is packet 7. Accordingly, when a match is found, control unit 205 may request the unicast stream 202 be stopped (e.g., teardown request), and the next packet to be sent to the decode stream 204 is packet 8 from the multicast buffer 215, which is a multicast packet. From this point, the two streams are considered to be spliced, and the multicast stream 201 is used as the decode stream 204.

As mentioned above, after the DTR 130 has performed the switch and splice from the unicast stream 202 to the multicast stream 201, the decode stream 204 is a delayed version of the original multicast stream 201 sent by the DVSS 14. In one embodiment, the control unit 205 of FIG. 2, may implement a catch-up feature that may increase the packet retrieval rate, and thus the subsequent decode and display of the buffered multicast packets so that eventually the multicast stream 201 may be directly passed through as the decode stream 204 without delay.

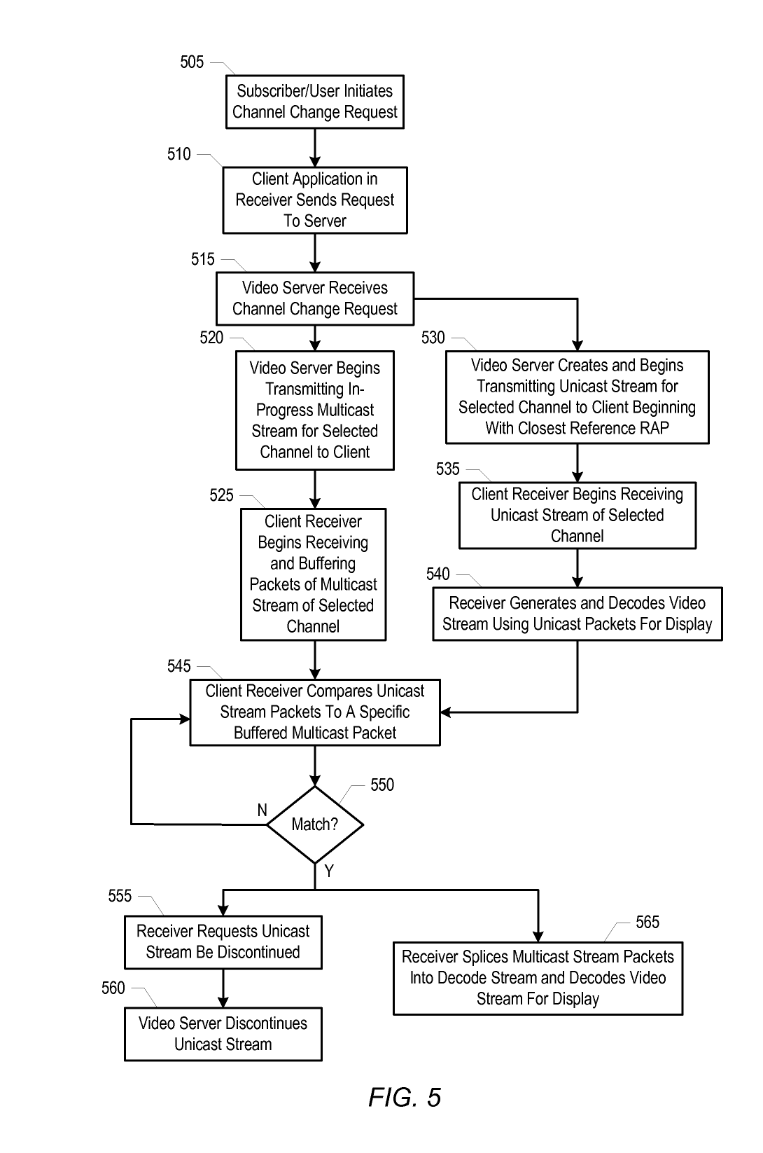

FIG. 5 is an operational flow diagram describing the operation of the embodiments of FIG. 1 through FIG. 4. Referring collectively to FIG. 1 through FIG. 5, and beginning in block 505 of FIG. 5, a subscriber/user may be viewing programming on a particular digital television channel and may initiate a channel change request. Accordingly, a client application running on the processing unit 210 of control unit 205 may send the request to the DVSS 14 using an out-of-band channel, for example. In one embodiment, the DTR/STB 130 may send the request, which may include an RTSP message (e.g., setup, play) to the DVSS 14, along with a message to join the multicast programming on the selected channel, for example (block 510). In response to receiving the request (block 515), the DVSS 14 sends the multicast stream 201 to the DTR/STB 130 (block 520). More particularly, typically the multicast stream is already being transmitted, and the DTR/STB 130 simply joins the multicast stream by sending an IGMP join message to the network. In addition, the DVSS 14 also creates and sends a unique unicast stream 202 (beginning with a RAP) that corresponds to and is concurrent with the multicast stream 201 for the selected channel (block 530). In one embodiment, the control unit 106 may locate the optimal RAP to use as the starting point of the unique unicast stream 202 based upon, for example, the RAP indices described above.

The DTR/STB 130 receives and buffers the packets of the multicast stream 201 within the multicast buffer 415, as described above (block 525). In addition, the DTR/STB 130 receives packets of the unicast stream 202 for the selected channel (block 535). The first received packet of the unicast stream 202 contains a RAP. As such, the RAP and subsequent packets of the unicast stream 202 may be sent directly as the decode stream 204 to be decoded and displayed (block 540).

In one embodiment, as each packet of the unicast stream 202 is received, control unit 205 compares the contents of each packet to one or more packets stored in the multicast buffer 415. As an example, as described above, and shown in FIG. 4, each packet of the unicast stream 202 is compared to packet 7 (block 545).

If there is no match (block 550), the control unit 205 continues to buffer multicast video stream packets and to compare them to unicast stream packets. However, if there is a match, in one embodiment, the client application running on the processing unit 210 may send a request to discontinue the unicast stream 202 (block 555). In one implementation, the request may be an RTSP teardown request. Accordingly, in response to the request the DVSS 14 stops the unicast stream 202.

Furthermore, once a matching packet has been found (block 550), the control unit 205 sends the subsequent multicast packets from the multicast buffer 415 to the decoder 220, where they are decoded and subsequently displayed (block 560). Specifically, in one embodiment, once the matching unicast packet is found, the next buffered multicast packet in the sequence is fed from the multicast buffer into the decode stream 204. From that point forward, the selected channel multicast stream 201 is used as the decode stream 204 for decode and display (block 565).

It is noted that although the flow diagram of FIG. 5 depicts various blocks in a particular order, it is contemplated that in other embodiments some of the blocks may occur in a different order while still achieving the desired functionality.

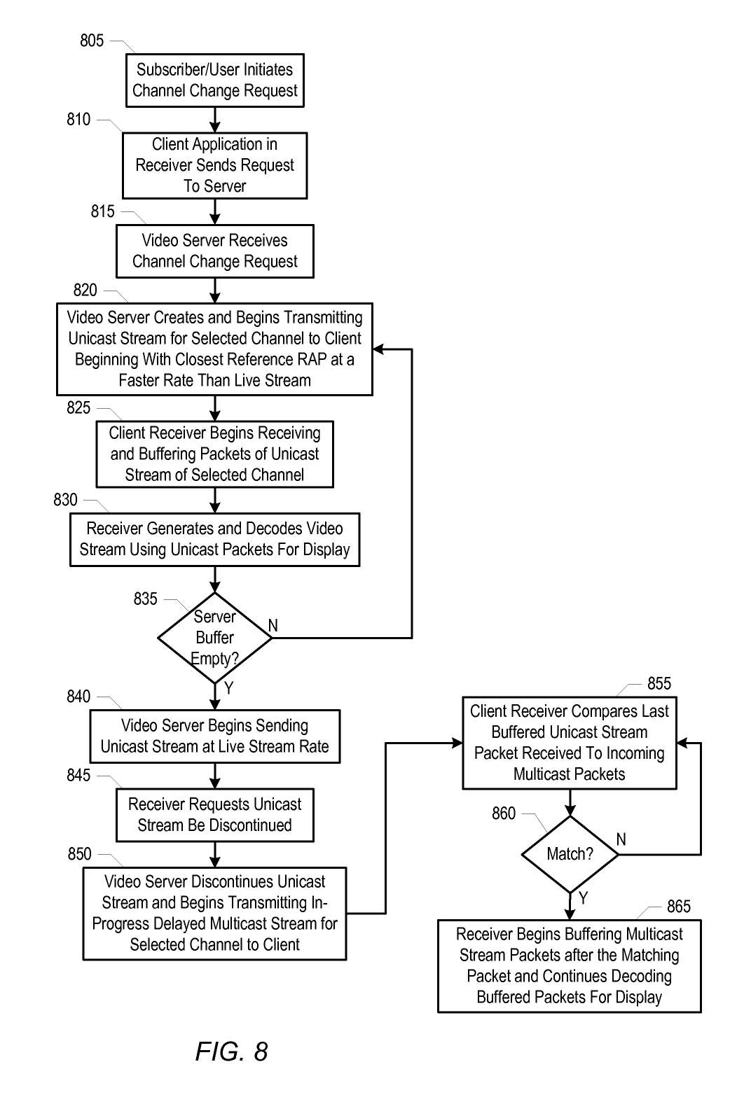

In an alternative embodiment, upon receiving a channel change request the DVSS 14 is configured to send a unicast stream. The DTR/STB 130 is configured to begin buffering, decoding and displaying the unicast stream 202. In the alternative embodiment, the DVSS 14 and the DTR/STB 130 may have similar components, however, their functionality may be different as described further below in conjunction with the descriptions of FIG. 6 through FIG. 8. More particularly, in the alternative embodiment, the DVSS 14 or other network component may not begin forwarding the multicast stream 201 until the DTR/STB 130 sends a message to the DVSS 14 some amount of time after receiving unicast stream packets. FIG. 6 and FIG. 7 illustrate timing diagrams that depict the operation of the alternative embodiment, while FIG. 8 illustrates a flow diagram the depicts the operation aspects of the alternative embodiments.

Turning to FIG. 6, an incoming digital feed 12 is received by a DVSS 14, which creates and transmits both a multicast stream 201 and an associated unicast stream 202. There is a timeline drawn on the bottom in which time proceeds from left to right. Beginning at t₀, packet 1 of the incoming digital feed 12 is received by the DVSS 14. At time t1, packet 1 is transmitted by the DVSS 14. Similar to FIG. 3, each of the multicast and unicast streams includes packets containing RAPs designated by the ‘R’. The delay designated as Δ1 represents the time taken by the DVSS 14 to receive packets of the digital feed 12, process the packets and add an additional delay designated as Δ6, and then send out the packets as multicast streams 201. This Δ6 delay is the maximum expected time for a DTR/STB 130 to acquire a multicast stream and start receiving packets. As described further below, this delay ensures that there will be a packet overlap between the multicast packets and the unicast packets to allow the DTR/STB 130 to compare the last unicast packet sent with the incoming multicast packets.

The delay Δ2 represents the delay associated with the time it takes the DVSS 14 to start transmitting the first unicast packet and the time the content is decoded in the unicast stream 202 in response to a channel change request occurring at time t3. The delay or skew between the live stream and the buffered stream is denoted as Δ3. Further, the delay Δ4 represents the channel change lag time from the time the user initiates a channel change request to the time the content is decoded in the multicast stream for a conventional system. The reduction in channel change lag of the illustrated embodiment corresponds to the difference between Δ4 and Δ2, which is similar to the embodiments described above in conjunction with the description of FIG. 1-FIG. 5.

Since the DVSS 14 does not begin sending packets from the multicast stream 201, the packets of the unicast stream 202 are sent at a faster rate than the packets in the multicast stream 201 from a buffer within the DVSS 14. Thus at time t4 the DVSS 14 begins sending the unicast stream beginning with packet 2 (i.e., a packet containing a RAP), and at time t4, the DTR begins buffering the unicast packets and then delivering them to the decoder 220, but at the live stream rate for display. At some point the buffer within the DVSS 14 will become depleted. At that time the DVSS 14 will begin sending the packets of the unicast stream at the live stream rate (e.g., at time t₆). This may correspond to the point at which the unicast stream 201 has caught up to the multicast stream 201. The period may of time that it takes to catch up is shown as Δ5.

Turning to FIG. 7, a conceptual diagram depicting an embodiment of stream splicing via the stream buffer of the receiver of FIG. 2. As described above, in response to a channel change request, the DVSS 14 starts the unicast stream 202 using packets that have been buffered from the live incoming feed 12, and beginning with a previous RAP (e.g., packet 2R). As the DTR 130 receives the unicast stream packets, packet 2R is passed directly through as the decode stream 204 to the decoder to be decoded and displayed. However, since the packets in the unicast stream are being sent at a faster rate than the live rate, the subsequent packets in the unicast stream 202 are buffered within stream buffer 715 and are passed from the stream buffer 715 as needed at the appropriate (i.e., live) stream rate. This is depicted by the arrows showing, for example, packets 3 and 4 of the unicast stream 202 being stored within stream buffer 715, and then being fed into the decode stream from the stream buffer 715. More particularly, the control unit 205 of FIG. 2, may begin storing the unicast stream 202 packets into a stream buffer 715 data structure such as a circular buffer structure within memory 215 until they are needed by the decoder 220.

At some point, the unicast stream 202 will catch up to the content that would be delivered in the corresponding multicast stream 201 for the selected channel. As mentioned above, the DVSS 14 will no longer have a surplus of unicast packets buffered. Accordingly, the DVSS 14 may begin sending the unicast stream 202 packets at or near the live stream rate. As mentioned above, the live stream rate of the packets in the unicast stream 202 are actually ahead of the multicast stream 201 packets by a period corresponding to Δ6. The control unit 205 may detect the rate change, and request the DVSS 14 discontinue the unicast stream 202 using, for example, an RTSP message to stop the unicast stream 202. This is shown occurring at packet 13 of the unicast stream 202 of FIG. 7. In one implementation, the DTR/STB 130 may send an RTSP “Announce” message indicating that the unicast and multicast streams are now synchronized.

The DTR/STB 130 issues a multicast join, for example, and begins receiving the multicast stream 201, which is delayed by Δ6. The control unit 205 may compare each incoming multicast stream packet with the last unicast stream packet (e.g., packet 13 of the unicast stream 202) to find a match. The Δ6 delay allows time for the comparison. When the control unit 205 finds the matching multicast stream packet (e.g., packet 13 of the multicast stream 201), the DTR/STB 103 may switch over to the multicast stream 201 so that packets 14 and 15, and so on, of the multicast stream 201 are stored within the stream buffer 715. As the decoder 220 needs packets, they are taken from the stream buffer 715 for decode and display. From this point, the two streams are considered to be spliced, and the multicast stream 201 is used as the decode stream 204.

Referring collectively now to FIG. 1, FIG. 2, and FIG. 6 through FIG. 8 and beginning in block 805 of FIG. 8, a subscriber/user may be viewing programming on a particular digital television channel and may initiate a channel change request. Accordingly, a client application running on the processing unit 210 of control unit 205 may send the request to the DVSS 14 using an out-of-band channel, for example. In one embodiment, the DTR/STB 130 may send the request, which may include an RTSP message (e.g., setup, play) to the DVSS 14, along with a message to join the multicast programming on the selected channel, for example (block 810). In response to receiving the request (block 815), the DVSS 14 creates and begins sending a unique unicast stream 202 (beginning with a RAP) corresponding to the multicast stream 201 for the requested channel (block 820). In one embodiment, the control unit 106 may locate the optimal RAP within a buffer to use as the starting point of the unique unicast stream 202 based upon, for example, the RAP indices described above. In one embodiment, the DVSS 14 sends the packets of the unicast stream 202 from a buffer within the DVSS 14, at a faster rate than the live stream rate (which corresponds to the rate at which the stream would be sent as a multicast stream for live viewing).

The DTR/STB 130 receives and buffers the packets of the unicast stream 202 within the stream buffer 715, as described above (block 825). Specifically, the first received packet (e.g., 2R) of the unicast stream 202 is a RAP, and as such, may be sent directly to the decoder 220 as the decode stream 204 to be decoded and displayed (i.e., thereby bypassing the stream buffer 715). However, the subsequent packets (e.g., packets 3-13) of the unicast stream 202 may be stored within the stream buffer 715 until they are needed by the decoder 220 for display (block 830).

The DVSS 14 may buffer some number of previous packets of one or more multicast streams 202. Accordingly, at some point after a unicast stream 202 is started, that buffer will be depleted. When the buffer in the DVSS 14 is empty (block 835), the DVSS 14 begins sending the packets of the unicast stream 202 at the live stream rate, which is slower (block 840). The control unit 205 of the DTR/STB 130 detects the rate change, and requests that the DVSS 14 discontinue the unicast stream 202 since the unicast stream 202 and the multicast stream 201 are now synchronized (block 845). The DVSS 14 receives the request and discontinues the unicast stream 202 and in one embodiment, begins sending the delayed multicast stream 201 to the requesting DTR/STB 130. In other embodiments, the DVSS 14 may already be broadcasting the delayed multicast stream 202, in which case the requesting DTR/STB 130 may begin receiving the delayed multicast stream 201 packets (block 850).

As described above, in one embodiment, the multicast stream 201 may be delayed to ensure that there will be a packet overlap between the multicast packets and the unicast packets to allow the DTR/STB 130 to compare the last unicast packet sent with the incoming multicast packets. The control unit 205 compares the last received packet of the unicast stream 202 with the incoming packets of the delayed multicast stream 201 (block 855) until there is a match (block 860). If there is a match, the control unit 205 begins storing the packets after the matching packet of the multicast stream 201 into the stream buffer 715. The decoder 220 continues to decode the packets from the stream buffer 715 as necessary for display (block 865). The streams are considered to be spliced once the multicast packets are being stored within the stream buffer 715.

It is noted that although the DVSS 14 shown in FIG. 1 is described as being used in a CATV system and an IPTV system, it is noted that the DVSS 14 may be used in any media distribution system including a video distribution system, and/or an audio distribution system that distributes video and/or audio to subscribers. In addition certain Internet Service Providers (ISP) having enough bandwidth may use such a streaming system to provide media distribution to their subscribers.

Although the embodiments above have been described in considerable detail, numerous variations and modifications will become apparent to those skilled in the art once the above disclosure is fully appreciated. It is intended that the following claims be interpreted to embrace all such variations and modifications.

What is claimed is:

1. A digital television receiver comprising:
a control unit configured to receive multicast video streams and unicast video streams, wherein each video stream includes a plurality of packets of video content;
a memory unit coupled to the control unit and configured to store the packets of video content;
wherein the control unit is configured to:
transmit a channel change request to a video server for a selected channel;
receive a reference packet followed by a plurality of successive packets corresponding to a unicast video stream for the selected channel, wherein the reference packet and a number of the successive packets occurred prior to a current packet of video content of a multicast video stream for the selected channel;
send the reference packet for decoding and display; and
store to the memory unit the plurality of successive packets corresponding to a unicast video stream for the selected channel;
receive and store to the memory unit a plurality of successive packets corresponding to the multicast video stream for the selected channel subsequent to receiving the plurality of successive packets corresponding to the unicast video stream;
retrieve from the memory unit and send for decode and display the successive packets of video content corresponding to the unicast video stream followed by the multicast video stream.

2. The digital television receiver as recited in claim 1, wherein the plurality of successive packets corresponding to the unicast video stream for the selected channel are received at a rate that is faster than a rate that corresponds to a multicast video stream live stream rate.

3. The digital television receiver as recited in claim 2, wherein the control unit is configured to request the unicast stream be discontinued in response to one of detecting a change in a delivery rate of the plurality of successive packets corresponding to the unicast video stream, or a particular message from the video server.

4. The digital television receiver as recited in claim 3, wherein the control unit is configured to store within the memory unit a portion of the plurality of successive packets corresponding to the multicast video stream for the selected channel beginning with a packet that matches a last received packet of the unicast video stream.

5. The digital television receiver as recited in claim 1, wherein the control unit is configured to transmit the channel change request to the video server for a selected channel using one or more commands compliant with a real time streaming protocol (RTSP) that is defined in request for comments (RFC) 2326.

6. The digital television receiver as recited in claim 1, further comprising a decoder configured to decode for display the successive packets of video content corresponding to the unicast video stream and the multicast video stream from the memory unit.

7. A digital video stream server comprising:
a control unit configured to generate and transmit a multicast video stream for each of a plurality of digital television channels for reception by one or more television receivers, wherein each video stream includes a plurality of packets of video content;
wherein the control unit is further configured to generate and transmit to a particular digital television receiver a unicast video stream for a selected channel at a rate that is faster than a rate that corresponds to a multicast video stream live stream rate in response to receiving a channel change request for the selected channel from the particular television receiver;
wherein the control unit is further configured to select and transmit as a first packet of the unicast video stream, a reference packet that occurred prior to a current packet of video content of a multicast video stream for the selected channel.

8. The digital video stream server as recited in claim 7, wherein the control unit is further configured to delay each packet of the multicast video stream by an amount corresponding to an amount of time required for a receiver to receive a transmitted multicast packet subsequent to issuing a request for the multicast stream.

9. The digital video stream server as recited in claim 7, wherein the control unit is further configured to transmit the multicast video stream for the selected channel in response to receiving a request from the particular television receiver to discontinue the unicast video stream for the selected channel.

10. The digital video stream server as recited in claim 7, wherein the control unit includes a processing unit configured to determine which reference packet of the video stream to transmit upon generating the unicast video stream.

11. The digital video stream server as recited in claim 7, further comprising a storage configured to store packets of the unicast video stream awaiting transmission to a television receiver.

12. The digital video stream server as recited in claim 11, wherein the control unit is further configured to transmit the unicast video stream for the selected channel at a rate that corresponds to the multicast video stream live stream rate in response to determining that the storage is empty.

13. A method comprising:
a digital receiver receiving multicast video streams and unicast video streams, wherein each video stream includes a plurality of packets of video content;
transmitting a channel change request to a video server for a selected channel;
receiving a reference packet followed by a plurality of successive packets corresponding to a unicast video stream for the selected channel, wherein the reference packet and a number of the successive packets occurred prior to a current packet of video content of a multicast video stream for the selected channel;
sending the reference packet for decoding and display; and
storing to a memory unit the plurality of successive packets corresponding to a unicast video stream for the selected channel;
receiving and storing to the memory unit a plurality of successive packets corresponding to the multicast video stream for the selected channel subsequent to receiving the plurality of successive packets corresponding to the unicast video stream;
retrieving from the memory unit and sending for decode and display the successive packets of video content corresponding to the unicast video stream followed by the multicast video stream.

14. The method as recited in claim 13, further comprising receiving the plurality of successive packets corresponding to the unicast video stream for the selected channel at a rate that is faster than a rate that corresponds to a multicast video stream live stream rate.

15. The method as recited in claim 13, further comprising requesting the unicast stream be discontinued in response to one of detecting a change in a delivery rate of the plurality of successive packets corresponding to the unicast video stream, or a particular message from the video server.

16. The method as recited in claim 13, further comprising storing within the memory unit a portion of the plurality of successive packets corresponding to the multicast video stream for the selected channel beginning with a packet that matches a last received packet of the unicast video stream.

18. A method comprising:
generating and transmitting a multicast video stream for each of a plurality of digital television channels for reception by one or more television receivers, wherein each video stream includes a plurality of packets of video content;
generating and transmitting to a particular digital television receiver a unicast video stream for a selected channel at a rate that is configurably faster than a rate that corresponds to a multicast video stream live stream rate in response to receiving a channel change request for the selected channel from the particular television receiver;
selecting and transmitting as a first packet of the unicast video stream, a reference packet that occurred prior to a current packet of video content of a multicast video stream for the selected channel.

19. The method as recited in claim 18, further comprising delaying each packet of the multicast video stream by an amount corresponding to an amount of time required for a receiver to receive a transmitted multicast packet subsequent to issuing a request for the multicast stream.

20. The method as recited in claim 18, further comprising transmitting the multicast video stream for the selected channel in response to receiving a request from the particular television receiver to discontinue the unicast video stream for the selected channel.

21. The method as recited in claim 18, further comprising transmitting the unicast video stream for the selected channel at a rate that corresponds to the multicast stream live stream rate in response to determining that a storage is empty.

22. A system comprising:
a digital video stream server configured to generate and transmit a multicast video stream for each of a plurality of digital television channels; and
a digital television receiver configured to receive the multicast video stream and to transmit a channel change request to the digital video stream server for a selected channel;
wherein the digital video stream server is further configured to generate and transmit to the digital television receiver a unique unicast video stream for the selected channel at a rate that is faster than a rate that corresponds to a multicast video stream live stream rate in response to receiving the channel change request for the selected channel, wherein each video stream includes one or more successive packets of video content;
wherein the digital video stream server is further configured to select and transmit as a first packet of the unicast video stream, a reference packet that occurred prior to a current packet of video content of a multicast video stream for the selected channel;
wherein the digital television receiver is further configured to receive the reference packet followed by a plurality of successive packets corresponding to the unicast video stream for the selected channel;
wherein the digital television receiver is further configured to send the reference packet for decoding and display upon receipt;
wherein the digital television receiver is further configured to receive and store to the memory unit a plurality of successive packets corresponding to the multicast video stream for the selected channel subsequent to receiving and storing the plurality of successive packets corresponding to the unicast video stream; and
wherein the digital television receiver is further configured to retrieve from the memory unit and send for decode and display the successive packets of video content corresponding to the unicast video stream followed by the multicast video stream in the order received.
